(19) United States
(12) Patent Application Publication
(10) Pub. No.: US 2021/0122889 A1
(43) Pub. Date: Apr. 29, 2021

(54) POST-HARVEST METHOD FOR NATURAL FIBER NANOPARTICLE REINFORCEMENT

(71) Applicant: Ford Global Technologies, LLC, Dearborn, MI (US)

(72) Inventors: Amy Ellen Langhorst, Ann Arbor, MI (US); Deborah Frances Mielewski, Ann Arbor, MI (US)

(73) Assignee: Ford Global Technologies, LLC, Dearborn, MI (US)

(21) Appl. No.: 16/661,569

(22) Filed: Oct. 23, 2019

(51) Int. Cl. C08J 5/06; C08J 5/00

(52) U.S. Cl. CPC C08J 5/06; C08J 5/005

(57) ABSTRACT

A method of forming a composite material includes immersing dried plant matter into an aqueous solution containing nanoparticles and applying a magnetic field and/or an electric field to the aqueous solution. A cellular structure of the dried plant matter expands when immersed in the aqueous solution and the nanoparticles migrate into and are embedded within the expanded cellular structure of the immersed dried plant matter. The method also includes removing at least one of hemicellulose, lignin and pectins from the dried plant matter by adding a chemical additive to the aqueous solution and/or wrapping or tagging the nanoparticles with a magnetic material such as nickel.

### FIELD

The present disclosure relates to natural fiber nanoparticle reinforcement.

### BACKGROUND

The statements in this section merely provide background information related to the present disclosure and may not constitute prior art.

Natural fibers have been investigated for use as reinforcements in polymer matrix composites due to their low density, lower cost, and lower abrasiveness relative to other synthetic fiber reinforcements such as glass or carbon. However, their strength, modulus, and degradation temperatures are lower than synthetic fibers, and natural fibers also have a tendency to absorb moisture. Lower mechanical properties as well as poor interfacial bonding between the fiber and matrix due to opposing polarities generally results in a non-structural composite.

Nanoparticle reinforced polymers have also been of interest in recent years, due to the ability of a very small quantity of filler/reinforcement to result in significant property improvements. However, nanoparticles tend to aggregate during processing, resulting in poor dispersion within the composite matrix. Additionally, nanoparticles are generally classified as hazardous substances, requiring special handling during processing.

These challenges with natural fiber and nanoparticle reinforced composites are addressed by the present disclosure.

### SUMMARY

In one form of the present disclosure, a method of forming a composite material includes immersing plant matter that has been dried into an aqueous solution containing nanoparticles and applying a magnetic field and/or electric field to the aqueous solution. A cellular structure of the dried plant matter expands when immersed in the aqueous solution and the nanoparticles are embedded within the expanded cellular structure of the immersed plant matter. In at least one variation the dried plant matter comprises a sheet of dried plant matter. In another variation the dried plant matter comprises individual plant cells. In some variations, the dried plant matter is selected from the group consisting of zucchini, corn, tomato, soybean, bitter melon, rapeseed, radish, ryegrass, lettuce, cucumber, cabbage, red spinach, faba bean, arabidopsis, carrot, onion, barley, rice, switchgrass, tobacco, wheat, garden cress, sorghum, mustard, alfalfa, onobrychis, pumpkin, garden pea, leek, peppers, flax, ryegrass, barley, agave, cattail, mung bean, cotton, algae, lemna gibba, cilantro, squash, bean, grasses, landoltia punctata, elsholtzia splendens, microcystis aeruginosa, elodea densa, bamboo, cane, carnation, monocot or dicot, blast fibers, lily, sugar cane, monocot, and Brassica rapa.

In some variations of the present disclosure, the method includes adding a chemical additive to the aqueous solution and thereby removing at least one of hemicellulose, lignin and pectins from the immersed plant matter. In such variations, the chemical additive can be at least one of an alkali, a silane, acetylation, benzoylation, peroxide, sodium chlorite, acrylic acid, stearic acid, triazine, and a fungus or enzyme.

In variations of the present disclosure, the nanoparticles include at least one of carbon-based nanoparticles, metal and/or metal oxide nanoparticles, polymer nanoparticles, inorganic nanoparticles, functionalized nanoparticles, carbon coated metal nanoparticles, and combinations thereof. Also, in some variations the nanoparticles are wrapped or tagged with a magnetic material, for example, nickel.

In some variations of the present disclosure, the method includes post-processing the plant matter with embedded nanoparticles after it is removed from the aqueous solution. In such variations the post-processing includes one or more of chopping, winding, chemical treatment, heat treatment, washing, radiation treatment, and steam explosion, among others. After the post-processing, the nanoparticle embedded plant matter can be mixed with a polymer to form a polymer-nanoparticle mixture and the polymer-nanoparticle mixture is used to form a part comprising nanoparticles mixed within a polymer matrix. In at least one form of the present disclosure, the part is included in a vehicle, e.g., a motor vehicle.

In another form of the present disclosure, a method of forming a composite material includes immersing dried plant fibers into an aqueous solution containing nanoparticles, applying a magnetic field and/or electric field to the aqueous solution, removing the plant fibers with embedded nanoparticles from the aqueous solution, mixing the nanoparticle embedded plant fibers with a polymer to form a polymer-nanoparticle mixture, and forming a part from the polymer-nanoparticle composite mixture. Immersing the dried plant fibers into the aqueous solution expands a cellular structure of the plant fibers such that the aqueous solution flows through the cellular structure. Also, the nanoparticles are embedded within the expanded cellular structure of the immersed plant fibers. In some variations, the nanoparticles include at least one of carbon-based nanoparticles, metal and/or metal oxide nanoparticles, polymer nanoparticles, inorganic nanoparticles, functionalized nanoparticles, carbon coated metal nanoparticles, and combinations thereof. In some variations of the present disclosure the method includes magnetically tagging the nanoparticles. In such variations, the nanoparticles can be wrapped or tagged with nickel.

In some variations, the method includes removing at least one of hemicellulose, lignin and pectins from the dried plant matter by adding a chemical additive to the aqueous solution. In such variations, the chemical additive is at least one of an alkali, a silane, acetylation, benzoylation, peroxide, sodium chlorite, acrylic acid, stearic acid, triazine, and a fungus or enzyme.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows dried plant matter;

FIG. 2A shows an enlarged view of section 2 in FIG. 1;

FIG. 2B shows a cross sectional view of section 2B-2B in FIG. 2A;

FIG. 3 shows dried plant matter immersed in an aqueous solution with nanoparticles according to one form of the present disclosure;

FIG. 4 shows the dried plant matter immersed in the aqueous solution with nanoparticles in FIG. 3 with a magnetic field applied to the aqueous solution according to the teachings of the present disclosure;

FIG. 5 shows nanoparticles embedded within the plant matter in FIG. 4 after being removed from the aqueous solution according to the teachings of the present disclosure;

FIG. 6 shows the plant matter with embedded nanoparticles in FIG. 5 mixed with a liquid polymer to form a polymer-nanoparticle mixture according to the teachings of the present disclosure;

FIG. 7 shows a component formed from the polymer-nanoparticle mixture in FIG. 6 according to the teachings of the present disclosure;

FIG. 8 shows dried plant matter immersed in an aqueous solution with nanoparticles according to another form of the present disclosure;

FIG. 9 shows dried plant matter immersed in an aqueous solution with nanoparticles according to still another form of the present disclosure;

FIG. 10A shows dried plant matter immersed in an aqueous solution with a chemical element according to still yet another form of the present disclosure;

FIG. 10B shows the dried plant matter immersed in the aqueous solution with the chemical element in FIG. 10A with the addition of nanoparticles according the still yet another form of the present disclosure; and

FIG. 11 shows a flow chart for a method of forming a composite part according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides an innovative composite material that is formed from natural fibers (e.g., dried plant fibers) that have accumulated or embedded nanoparticles, in which the natural fibers have improved mechanical properties due to the presence of the nanoparticles. The composite material, i.e., the natural fibers with embedded nanoparticles, is combined with a polymer matrix to form a polymer-nanoparticle mixture which may be processed in any number of ways to create lightweight, strong, and sustainable parts, particularly for use in motor vehicles.

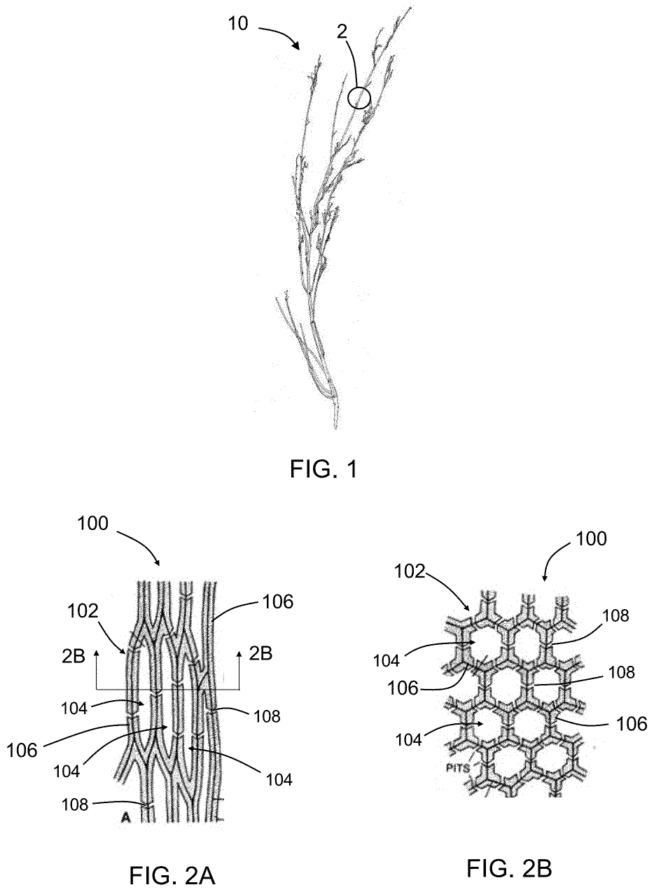

Referring to FIGS. 1 and 2A-2B, dried plant material 10 is shown in FIG. 1 and an enlarged view of fibers 100 of the dried plant material 10 is shown in FIGS. 2A-2B. The fibers 100 have a cellular structure 102 (FIGS. 2A and 2B) that includes cells 104 defined by cell walls 106 and the cell walls 106 have pores and/or pits 108 (simply referred to herein as “pores”). It should be understood that the dried plant matter 10 also includes other components (not shown) such as cellulose, hemicellulose, lignin and pectins, among others.

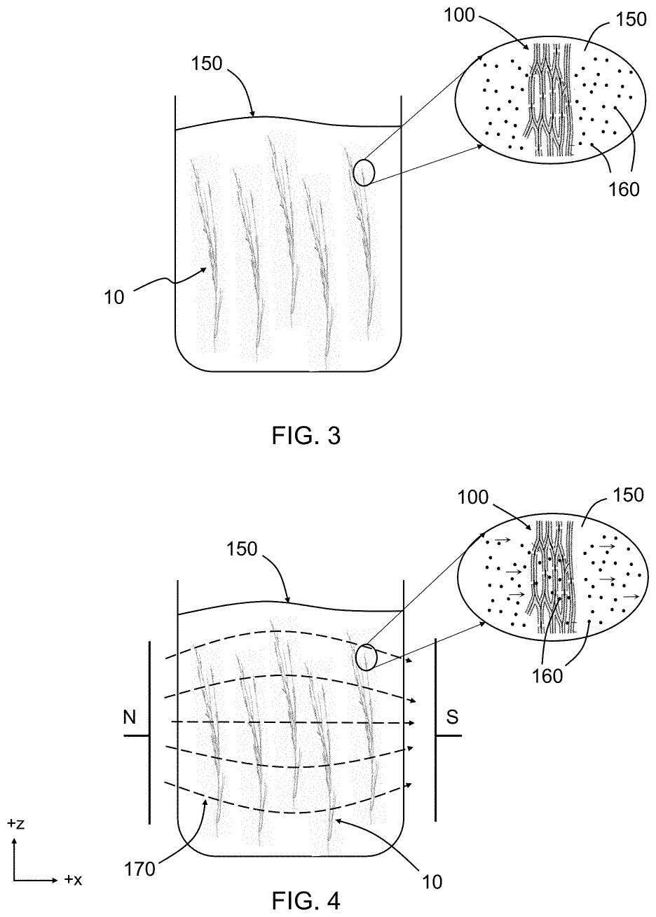

Referring now to FIG. 3, a step fora method of forming a composite material according to the teachings of the present disclosure is shown. The method includes immersing the dried plant material 10 (i.e., post-harvest) into an aqueous solution 150 containing nanoparticles 160. Immersing the dried plant material 10 (also referred to herein simply as “immersed plant material 10”) into the aqueous solution 150 expands the cellular structure 102 of the fibers 100 such that the flow of the aqueous solution 150 and the nanoparticles 160 through the fibers 100 is enhanced.

Referring now to FIG. 4 another step for a method of forming a composite material according to the teachings of the present disclosure is shown. Particularly, a magnetic field 170 is applied to the aqueous solution 150 containing the nanoparticles 160 and the immersed plant material 10. In some variations of the present disclosure, the nanoparticles 160 are wrapped or tagged with a magnetic material. In such variations, the nanoparticles 160 respond to the magnetic field 170 by moving or migrating within the aqueous solution 150 in a direction from a North pole ‘N’ of the magnetic field 170 towards a South pole ‘S’ of the magnetic field 170 as shown by the arrows in the figure (+x direction). Also, the nanoparticles 160 flow relative to the immersed plant material 10 such that the nanoparticles 160 move into contact with and/or within the fibers 100. Stated differently, the nanoparticles 160 become embedded in the fiber 100. In the alternative, or in addition to, an electric field (not labeled, but represented by the dotted arrow lines in FIG. 4) can be applied to the aqueous solution 150 containing the nanoparticles 160 and the immersed plant material 10. Also, the nanoparticles 160, with or without being wrapped or tagged with a magnetic material, respond to the electric field by moving or migrating within the aqueous solution 150 such that the nanoparticles 160 move into contact with and/or within the fibers 100.

In some variations of the present disclosure the nanoparticles 160 flow through the pores 108 of cell walls 106 such that nanoparticles 160 are embedded within individual cells 100. In other variations, the nanoparticles 160 flow between individual cells 100 such that nanoparticles 160 are embedded between individual cells 104 and/or on cell walls 106. In still other variations, the nanoparticles 160 flow through the pores 108 of cell walls 106 and between individual cells 104 such that nanoparticles 160 are embedded within individual cells 104 and embedded between individual cells 104 and/or on cell walls 106. It should be understood that the expanded cellular structure 102 of the fibers 100 enhances the flow of the nanoparticles 160 into contact with and/or within the fibers 100.

In some variations of the present disclosure, the aqueous solution 150 includes a chemical additive that enhances removal of one or more components of the dried plant material 10. For example, in at least one variation, the chemical additive enhances the removal of hemicellulose, lignin and/or pectins from the dried plant material 10. Non-limiting examples of the chemical additive include an alkali, a silane, acetylation, benzoylation, peroxide, sodium chlorite, acrylic acid, stearic acid, triazine, and a fungus or enzyme, among others. It should be understood that removing the one or more components of the dried plant material 10 enhances the flow of the aqueous solution 150 and nanoparticles 160 through the fibers 100 thereby increasing the amount or number of nanoparticles embedded in the fibers 100.

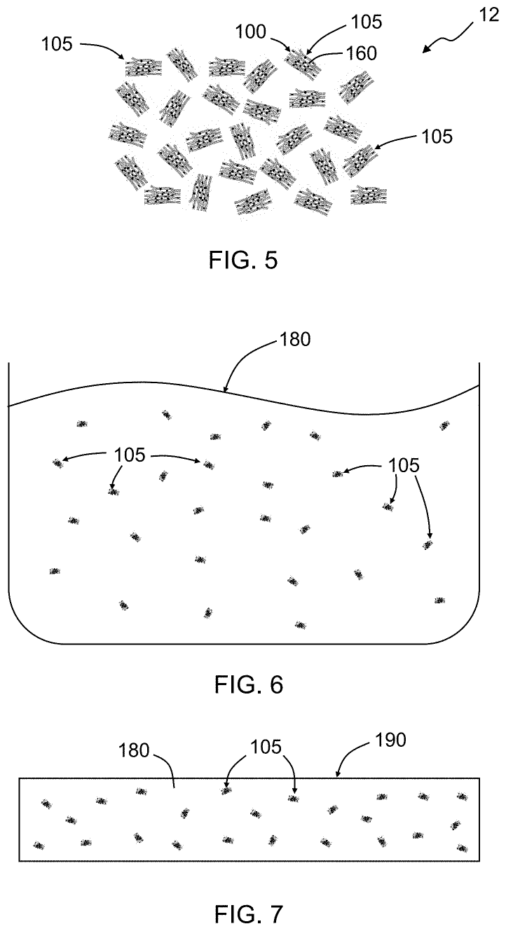

Referring now to FIG. 5, a composite material 12 in the form of a plurality of nanoparticle embedded fibers 105 comprising fibers 100 embedded with nanoparticles 160 is shown. For example, in some variations of the present disclosure the fibers 100 with embedded nanoparticles 160 are removed from the aqueous solution 150, dried, and post-processed to provide the plurality of nanoparticle embedded fibers 105. Non-limiting examples of post-processing the immersed plant material 10 with embedded nanoparticles 160 includes chopping, winding, chemical treatment (e.g., alkali treatment), heat treatment, washing, radiation treatment (e.g., UV, plasma, corona), and steam explosion, among others.

Non-limiting examples of the fibers 100 include fibers of dried plant matter such as dried zucchini, corn, tomato, soybean, bitter melon, rapeseed, radish, ryegrass, lettuce, cucumber, cabbage, red spinach, faba bean, arabidopsis, carrot, onion, barley, rice, switchgrass, tobacco, wheat, garden cress, sorghum, mustard, alfalfa, onobrychis, pumpkin, garden pea, leek, peppers, flax, ryegrass, barley, agave, cattail, mung bean, cotton, algae, lemna gibba, cilantro, squash, bean, grasses, landoltia punctata, elsholtzia splendens, microcystis aeruginosa, elodea densa, bamboo, cane, carnation, monocot or dicot, blast fibers, lily, sugar cane, monocot, and Brassica rapa, among others. Other non-limiting examples of fibers include wood derived fibers such as bast fibers. Also, non-limiting examples of nanoparticles 160 include carbon-based nanoparticles, metal and/or metal oxide nanoparticles, polymer nanoparticles, inorganic nanoparticles, functionalized nanoparticles, carbon coated metal nanoparticles, and combinations thereof. In variations where the nanoparticles are wrapped or tagged with a magnetic material, non-limiting examples of the magnetic material include nickel, iron, cobalt, and hematite (Fe₂O₃), among others.

Referring now to FIGS. 6 and 7, steps for a method of forming a part from the composite material 12 according to the teachings of the present disclosure is shown. Particularly, the plurality of nanoparticle embedded fibers 105 shown in FIG. 5 is mixed within a polymer 180 (e.g., in liquid form) in FIG. 6 to form a polymer-nanoparticle mixture and the polymer-nanoparticle is used to form a part 190 in FIG. 7. As shown in FIG. 7, the nanoparticle embedded fibers 105 are in a matrix of the polymer 180 (in solid form and also referred to herein as a “polymer matrix”). Non-limiting examples of the polymer 180 include thermoset or thermoplastics such as polyolefins, polyamides and polyurethanes, among others.

It should be understood that embedding the nanoparticles 160 within the fibers 100, and then mixing the nanoparticle embedded fibers 105 with the polymer 180 reduces agglomeration of the nanoparticles 160 within the polymer 180. That is, agglomeration of nanoparticles within liquids is known and treatment of nanoparticle surfaces to reduce agglomeration has been studied. However, agglomeration of plant fibers in liquids is less pronounced, when compared with agglomeration of nanoparticles, and embedding nanoparticles within plant fibers provides a polymer-nanoparticle composite with reduced nanoparticle agglomeration.

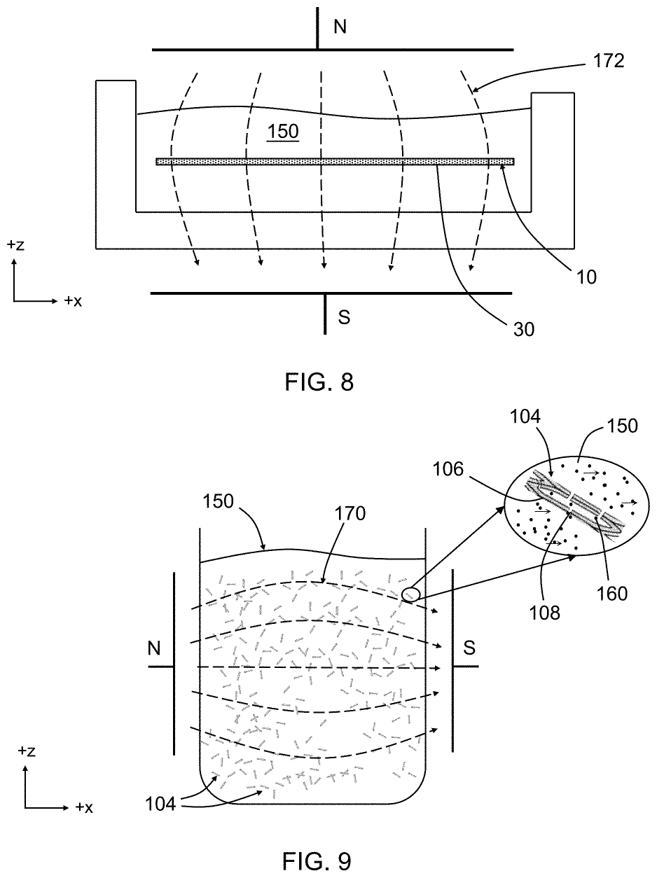

Referring now to FIG. 8, in another form of the present disclosure, a sheet 30 of the dried plant material 10 immersed within the aqueous solution 150 containing the nanoparticles 160 is shown. A magnetic 172 is applied to the aqueous solution 150 and similar to the teachings above with respect to FIGS. 3 and 4, immersing the sheet 30 into the aqueous solution 150 expands the cellular structure 102 of the fibers 100. Also, the magnetic field 172 moves or migrates the nanoparticles 160 within the aqueous solution 150 in a direction from a North pole ‘N’ of the magnetic field 172 towards a South pole ‘S’ of the magnetic field (−z direction) such that the nanoparticles 160 become embedded in the fibers 100. In the alternative, or in addition to, an electric field (not labeled, but represented by the dotted arrow lines in FIG. 8) can be applied to the aqueous solution 150 containing the nanoparticles 160 and the sheet 30. Also, the nanoparticles 160, with or without being wrapped or tagged with a magnetic material, respond to the electric field by moving or migrating within the aqueous solution 150 such that the nanoparticles 160 move into contact with and/or within the fibers 100.

It should be understood that the expanded cellular structure 102 of the fibers 100 enhances the flow of the nanoparticles 160 into contact with and/or through the fibers 100. It should be also understood that the sheet 30 of immersed plant material 10 with embedded nanoparticles 160 is removed from the aqueous solution and post-processed as discussed above with respect to FIGS. 5, 6 and/or 7.

Referring now to FIG. 9, in still another form of the present disclosure, individual cells 104 of the fibers 100 immersed in the aqueous solution 150 containing the nanoparticles 160 is shown and the magnetic field 170 is applied to the aqueous solution 150. Similar to the teachings above with respect to FIGS. 3 and 4, immersing the individual cells 104 of the fibers 100 into the aqueous solution 150 expands their cellular structure 102. Also, applying the magnetic field 170 moves or migrates the nanoparticles within the aqueous solution 150 in a direction from the North pole ‘N’ of the magnetic field 170 towards the South pole ‘S’ of the magnetic field 170 such that the nanoparticles 160 are embedded within the cells 104. In the alternative, or in addition to, an electric field (not labeled, but represented by the dotted arrow lines in FIG. 9) can be applied to the aqueous solution 150 containing the nanoparticles 160 and individual cells 104 of the fibers 100. Also, the nanoparticles 160, with or without being wrapped or tagged with a magnetic material, respond to the electric field by moving or migrating within the aqueous solution 150 such that the nanoparticles 160 move into contact with and/or within the individual cells 104.

In some variations of the present disclosure the nanoparticles 160 flow through the pores 108 of cell walls 106 such that nanoparticles 160 are embedded within individual cells 104. In other variations, the nanoparticles 160 are embedded on the cell walls 106 of the individual cells 104. In still other variations, the nanoparticles 160 flow through the pores 108 of cell walls 106 and are embedded within individual cells 100, and are also embedded on cell walls 106. It should be understood that the expanded cellular structure 102 of the individual cells 104 enhances the flow of the nanoparticles 160 within the individual cells 104. It should also be understood that the cells 104 with embedded nanoparticles 160 are removed from the aqueous solution and further processed as discussed above with respect to FIGS. 5, 6 and/or 7.

While FIGS. 4, 8 and 9 illustrate the magnetic field applied in only one direction, it should be understood that one or more magnetic fields can be applied in more than one direction. For example, an electric field applied across an aqueous solution containing nanoparticles and immersed plant matter can be an alternating electric field such that a magnetic field alternates between one direction and an opposite direction (e.g., +/−x directions in FIGS. 4 and 9). Also, one or more magnetic fields across an aqueous solution containing nanoparticles and immersed plant matter can be rotated, e.g., about the x, y and/or z axes in the figures, such that a magnetic field is applied in more than one direction across the aqueous solution.

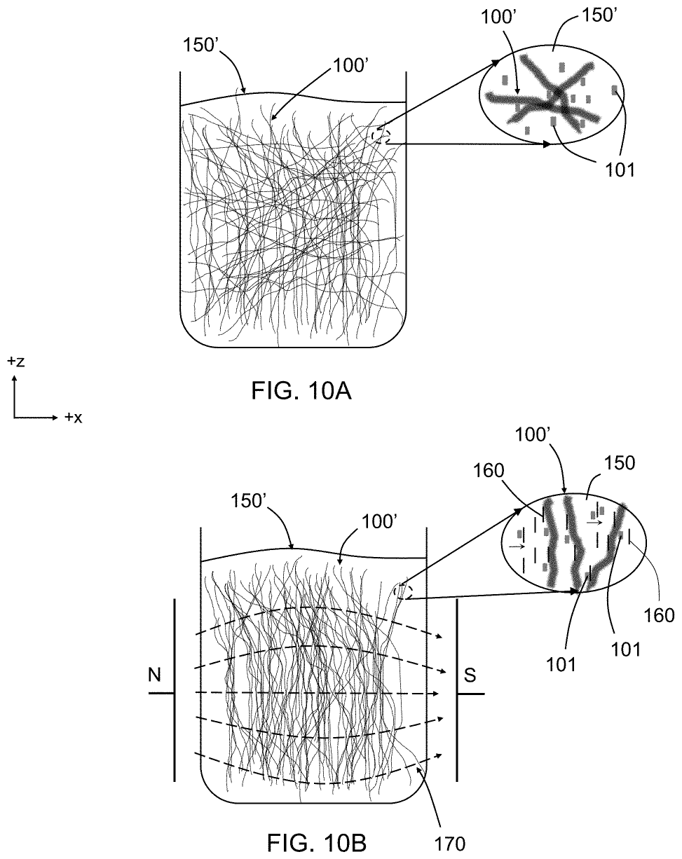

Referring now to FIGS. 10A and 10B, in still yet another form of the present disclosure, cellulose fibers 100′ immersed in an aqueous solution 150′ containing a chemical element that breaks up or breaks down the crystalline structure of the cellulose fibers 100′ is shown in FIG. 10A and the magnetic field 170 is applied to the aqueous solution 150′ in FIG. 10B. For example, in one variation an aqueous solution containing sodium hydroxide (NaOH) is used to break down the cellulose fibers 100′. In at least one variation the cellulose fibers 100′ are broken down such that a sol gel or sol gel-type mixture with a desired amount or percentage of the cellulose fiber 100′ broken down into glucose subunits 101 is provided (FIG. 10A). It should be understood that hemicellulose and lignin (not shown) can also be broken down by the aqueous solution 150′. It should also be understood that a first portion of the glucose subunits 101 can be dissolved into the aqueous solution 150′ while a second portion of the glucose subunits 101 can be suspended in the aqueous solution 150′ and/or attached or clinging to remaining cellulose fiber 100′ such that a mixture of cellulose fibers 100′ and glucose subunits 101 are immersed and/or suspended in the aqueous solution 150′.

Referring to FIG. 10B, in some variations of the present disclosure nanoparticles 160 are added to the aqueous solution 150′ after the crystalline structure of the cellulose fibers 100′ is broken down a desired amount. Also, before, during or after the nanoparticles 160 are added to the aqueous solution 150′ the magnetic field 170 is applied across the aqueous solution 150′. In such variations, the nanoparticles 160 migrate or move within the aqueous solution 150 in a direction from the North pole ‘N’ of the magnetic field 170 towards the South pole ‘S’ of the magnetic field 170 such that the nanoparticles 160 are embedded onto the cellulose fibers 100′. Also, the glucose subunits 101 assist with embedding or attaching the nanoparticles onto the cellulose fibers 100′. For example, a nanoparticle 160 can be embedded within and/or attached to one or more glucose subunits 101, and as the nanoparticle 160 migrates or moves under the influence of the magnetic field 170, the one or more glucose subunits 101 attach or re-attach to a cellulose fiber 100′ such that the nanoparticle 160 is also attached or embedded on the cellulose fiber 100′. In the alternative, or in addition to, an electric field (not labeled, but represented by the dotted arrow lines in FIG. 10B) can be applied to the aqueous solution 150′ containing the nanoparticles 160 and the cellulose fibers 100′. Also, the nanoparticles 160, with or without being wrapped or tagged with a magnetic material, respond to the electric field by moving or migrating within the aqueous solution 150 such that the nanoparticles 160 move into contact with and/or within cellulose fibers 100′.

In some variations of the present disclosure the nanoparticles 160 are added to the aqueous solution 150′ and/or the magnetic field 170 (and/or electric field) is applied across the aqueous solution 150′ during or after the cellulose fibers 100′ are aligned in a desired direction. For example, and as illustrated in FIG. 10B, in at least one variation the cellulose fibers 100′ are generally aligned in the z direction. Also, elongated nanofibers 160 (e.g., magnetically tagged carbon nanotubes) have been aligned in the z direction such that a length (z direction in FIG. 10B) of the nanoparticles 160 is aligned with or generally parallel to the length of the cellulose fibers 100′. For example, in at least one variation, the nanoparticles 160 are added to the aqueous solution 150′ and/or the magnetic field 170 (and/or electric field) is applied across the aqueous solution 150′ during removal of the cellulose fibers 100′ from the aqueous solution 150′ and/or straining of the cellulose fibers 100′ from the aqueous solution 150′. That is, during removal (e.g., pulling) of the cellulose fibers 100′ from the aqueous solution 150′ the cellulose fibers 100′ generally align along the z direction shown in FIG. 10B and addition of the nanoparticles 160 and/or applying the magnetic field 170 (and/or electric field) at this time enhances a desired orientation of the nanoparticles 160 relative to the cellulose fibers 100′. Accordingly, it should be understood that in such variations the nanoparticles 160 are embedded within and/or attached to the cellulose fibers 100′ with a desired orientation (e.g., length of nanoparticles aligned with length of fibers). It should also be understood that the cellulose fibers 100′ with embedded and/or attached nanoparticles 160 are removed from the aqueous solution and further processed as discussed above with respect to FIGS. 5, 6 and/or 7.

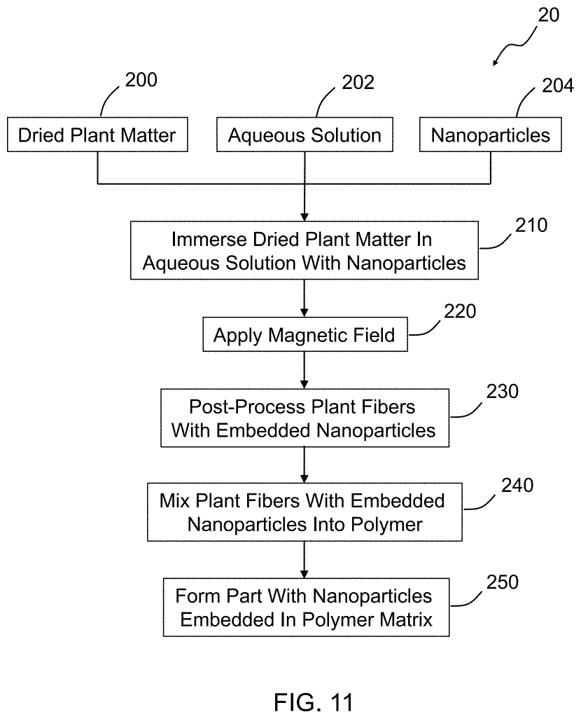

Referring now to FIG. 11, a flow chart for a method 20 of forming a composite material and a composite part is shown. The method includes providing dried plant matter at 200, an aqueous solution at 202, and nanoparticles at 204. In some variations of the present disclosure the aqueous solution provided at 200 includes a chemical additive and/or the nanoparticles provided at 204 are magnetically tagged. The dried plant matter is immersed in the aqueous solution at 210 such that the cellular structure of the fibers of the dried plant matter expands. In some variations, the nanoparticles are mixed with the aqueous solution before the dried plant matter is immersed in the aqueous solution, while in other variations the nanoparticles are mixed with the aqueous solution after the dried plant matter is immersed in the aqueous solution. Similarly, in variations where the aqueous solution contains the chemical additive, in at least one variation, the chemical additive is mixed with the aqueous solution before the dried plant matter is immersed in the aqueous solution, while in at least one other variation the chemical additive is mixed with the aqueous solution after the dried plant matter is immersed in the aqueous solution. In variations where the chemical additive is added to the aqueous solution, the chemical additive enhances removal of one or more components of the dried plant material (e.g., hemicellulose, lignin and/or pectins) such that the cellular structure of the fibers further expands compared to the expansion of the fiber cellular expansion resulting from immersion in the aqueous solution alone.

Still referring to FIG. 11, a magnetic field (and/or electric field) is applied to the aqueous solution (with nanoparticles) containing the immersed plant matter at 220 such that the nanoparticles in the aqueous solution are embedded in fibers of the immersed plant material. After the nanoparticles in the aqueous solution are embedded in fibers of the immersed plant material, the nanoparticle embedded plant fibers are removed from the aqueous solution and are post-processed at 230 before mixing with a polymer at 240. Mixing the nanoparticle embedded plant fibers with the polymer forms a polymer-nanoparticle mixture and the polymer-nanoparticle mixture is used to form a part at 250 with nanoparticles embedded in a polymer matrix. In at least one variation of the present disclosure, the polymer-nanoparticle mixture is a liquid-nanoparticle mixture that is poured into a mold to make the part. In at least one other variation, the polymer-nanoparticle mixture is a liquid-nanoparticle mixture that is solidified, granulated and/or pulverized into granules and/or powder, and then used as injection molding material to make the part.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of forming a composite material comprising:
immersing dried plant matter into an aqueous solution containing nanoparticles, wherein a cellular structure of the dried plant matter expands when immersed in the aqueous solution; and
applying at least one of a magnetic field and an electric field to the aqueous solution such that the nanoparticles migrate into and are embedded within the expanded cellular structure of the immersed dried plant matter.

2. The method according to claim 1 further comprising adding a chemical additive to the aqueous solution, wherein the chemical additive removes at least one of hemicellulose, lignin and pectins from the dried plant matter.

3. The method according to claim 2, wherein the chemical additive is at least one of an alkali, a silane, acetylation, benzoylation, peroxide, sodium chlorite, acrylic acid, stearic acid, triazine, and a fungus or enzyme.

4. The method according to claim 1, wherein the dried plant matter comprise a sheet of dried plant matter.

5. The method according to claim 1, wherein the dried plant matter comprises individual plant cells.

6. The method according to claim 1, wherein the nanoparticles are selected from the group consisting of carbon-based nanoparticles, metals and/or metal oxide nanoparticles, polymer nanoparticles, inorganic nanoparticles, functionalized nanoparticles, carbon coated metal nanoparticles, and combinations thereof.

7. The method according to claim 6, wherein the nanoparticles are wrapped or tagged with nickel.

8. The method according to claim 7, wherein the dried plant matter is selected from the group consisting of zucchini, corn, tomato, soybean, bitter melon, rapeseed, radish, ryegrass, lettuce, cucumber, cabbage, red spinach, faba bean, arabidopsis, carrot, onion, barley, rice, switchgrass, tobacco, wheat, garden cress, sorghum, mustard, alfalfa, onobrychis, pumpkin, garden pea, leek, peppers, flax, ryegrass, barley, agave, cattail, mung bean, cotton, algae, lemna gibba, cilantro, squash, bean, grasses, landoltia punctata, elsholtzia splendens, microcystis aeruginosa, elodea densa, bamboo, cane, carnation, monocot or dicot, blast fibers, lily, sugar cane, monocot, Brassica rapa, and combinations thereof.

9. The method according to claim 1 further comprising removing the immersed dried plant matter with embedded nanoparticles from the aqueous solution, drying the plant matter with embedded nanoparticles, and mixing the plant matter with embedded nanoparticles within a polymer matrix.

10. The method according to claim 9 further comprising post-processing the dried plant matter with embedded nanoparticles prior to mixing within the polymer matrix.

11. The method according to claim 10, wherein the post-processing comprises chopping, winding, chemical treatment, heat treatment, washing, radiation treatment, and steam explosion, among others.

12. A part formed of the composite material formed according to claim 1.

13. A vehicle having at least one part according to claim 12.

14. A method of forming a composite material comprising:
immersing dried plant fibers into an aqueous solution containing nanoparticles, wherein a cellular structure of the dried plant fibers expands such that the aqueous solution flows through the cellular structure;
applying at least one of a magnetic field and an electric field to the aqueous solution such that the nanoparticles move relative to the immersed dried plant fibers and embed within the expanded cellular structure;
removing the immersed dried plant fibers with embedded nanoparticles from the aqueous solution;
mixing the removed dried plant fibers with embedded nanoparticles with a polymer and forming a polymer-nanoparticle mixture; and
forming a part using the polymer-nanoparticle mixture, wherein the part comprises the nanoparticles within a polymer matrix.

15. The method according to claim 14 further comprising magnetically tagging the nanoparticles.

16. The method according to claim 15, wherein the nanoparticles are wrapped or tagged with nickel.

17. The method according to claim 16, wherein the nanoparticles are selected from the group consisting of carbon-based nanoparticles, metals and/or metal oxide nanoparticles, polymer nanoparticles, inorganic nanoparticles, functionalized nanoparticles, carbon coated metal nanoparticles, and combinations thereof.

18. The method according to claim 14 further comprising removing at least one of hemicellulose, lignin and pectins from the dried plant matter by adding a chemical additive to the aqueous solution.

19. The method according to claim 18, wherein the chemical additive is at least one of an alkali, a silane, acetylation, benzoylation, peroxide, sodium chlorite, acrylic acid, stearic acid, triazine, and a fungus or enzyme.

20. A part formed of the composite material formed according to claim 14.
